(19) United States
(12) Patent Application Publication
(10) Pub. No.: US 2005/0002471 A1
(43) Pub. Date: Jan. 6, 2005

(54) Systems and methods for low loss monolithic extremely high frequency quadra-phase shift key modulation

(76) Inventors: Fred C. Tramm, Rancho Palos Verdes, CA (US); James P. Newman, Torrance, CA (US)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 10/611,525

(22) Filed: Jul. 1, 2003

(51) Int. Cl. H04L 27/20

(52) U.S. Cl. 375/308

(57) ABSTRACT

The present invention relates to systems and methods that reduce quadra-phase shift key (QPSK) modulator assembly size, cost and complexity via employing microwave monolithic integrated circuit (MMIC) technology. The systems and methods provide MMICs that include positive-intrinsic-negative (PIN) diodes as phase shifters (e.g., binary, reflective, hybrid and switched filter) that mitigate the tight thermal control, complex drive electronics and calibration routines associated with conventional ferrite phase shifters. The systems and methods can be employed in connection with antenna auto-tracking system such as those associated with satellites, aircrafts and spacecrafts. Employing MMIC technology provides for chips that can be consistently fabricated for extremely high frequency (EHF) operation, and that can increase system performance via mitigating parasitic reactance.

### BACKGROUND OF THE INVENTION

1. Field of the Invention

The present invention relates to systems and methods that facilitate signal modulation, and in particular to a PIN diode switch based delay line quadra-phase shift key (QPSK) modulator based on microwave monolithic integrated circuit (MMIC) technology.

2. Discussion of the Related Art

Advancements in electrical/electronical technologies have lead to more compact and reduced power embedded signal processing chips that can be employed in connection with virtually any device(s) to processes analog, digital and/or radio frequency (RF) signals. Several examples of such devices include personal computers (PCs), automobiles, cell phones, aircraft, satellites and spacecraft.

Personal computers have become indispensable household items. They are utilized for managing finances, controlling security, heating and lighting systems, providing entertainment, preparing meals (e.g., the microwave) and bridging people to the endless amount of information available through the Internet. In the workplace, they are powerful engines that solve problems and facilitate development of technologies that improve the standard of living of humanity. In automobiles, signal processors control ignition systems (e.g., fuel injection and timing), provide diagnostics (e.g., oil pressure, water temperature and fuel levels) and ensure safety (e.g., door ajar and seat belt not fastened). Additionally, signal processors can be employed in navigation and roadside emergency systems. In cell phones, signal processors facilitate communication (e.g., voice, email and text messaging), data exchange (e.g., images and files) and access to the Internet.

Advances in signal processing are readily apparent in the aerospace industry. Some aerospace manufacturers employ signal processing instrumentation on board fixed wing aircraft for applications such as land surveying. Collected data can be processed to generate video with high dynamic range. Other systems contain finely tuned sensors that are coupled with powerful signal processing algorithms to provide tools employed to process information from various spectral bands. For example, reflected light, including light associated with wavelengths, or frequencies invisible to humans, can be collected and employed to generate unique spectral footprints for objects such as soil, water, trees, vegetation, structures, metals, paints and fabrics. Such information can then be utilized to discriminate objects, for example to determine whether a tree is a maple or an oak.

Industry and consumer demand for more powerful, faster, smaller, and less expensive processors and peripherals has driven the technology industry to produce generation after generation of processing devices. However, signal processing integrated circuits (ICs) are limited by the current state of electrical/electronical technologies. As a result, overall satisfaction and system performance typically is less than industry and consumer demand.

By way of example, limitations in conventional chip technology utilized with phase shift modulators have lead to relatively large assemblies with complex drive electronics. Such modulators commonly employ ferrite phase shifters, which can be temperature and frequency sensitive, and thus component design typically includes tight thermal control and various calibration routines. The foregoing can lead to costly phase shifting integrated chips that generally cannot be fabricated for consistent performance.

### SUMMARY OF THE INVENTION

The present invention provides systems and methods that facilitate antenna auto-tracking via microwave monolithic integrated circuit (MMIC) technology incorporating positive-intrinsic-negative (PIN) Diode switch based delay line quadra-phase shift key (QPSK) modulation. In general, antenna auto-tracking can include automatically positioning the antenna (or device associated with the antenna) and/or another object (e.g., a remote transceiver) such that at least one of the foregoing can follow, or lock on to the other's relative movement. Transmitted/received information can include data such as a location and motion (e.g., speed and direction) employed to maintain tracking. For example, one of the foregoing can be mobile (e.g., via water, ground, air and/or space), wherein the information can be employed for repositioning to follow any movement.

Antenna signal auto tracking (e.g., signal pointing) systems typically utilize pseudo-monopulse systems employing QPSK modulation at the antenna receive frequency from a feed difference path. Current industry standards for extremely high frequency (EHF) operation employ QPSK modulators with ferrite based phase shifters, which provide for low (<3 dB) insertion loss and low (<500 Hz) modulation rate. However, ferrite phase shifters can be temperature and frequency sensitive, and therefore, tight thermal control (<10 degrees Celsius) and complex drive electronics incorporating calibration routines for acceptable performance generally are employed. In addition, the physical size and complexity of the phase shifters, and associated drive electronics and thermal controls can make these assemblies costly.

The systems and methods of the present invention employ MMIC based QPSK modulators with PIN diode phase shifters that reduce assembly size, cost and complexity associated with conventional ferrite phase shifters. MMIC PIN diodes can be employed as a switching device to transmit radio frequency (RF) signals through various lengths of transmission lines. Respective line transmission lengths introduce time delays, for example, in multiples of 90 degrees of phase rotation, including 0 degrees, 90 degrees, 180 degrees and 270 degrees. Employing such MMICs provides for phase shifters that can be consistently fabricated for extremely high frequency (EHF) operation. In addition, utilizing MMICs can reduce footprint and assembly cost, and increase performance via mitigating parasitic reactance.

In one aspect of the present invention, a system is provided that receives and modulates a signal. The received signal can be a signal associated with a transmitting device or a local microprocessor based device that processes information for transmission to other devices. The system can include a quadra-phase shift key (QPSK) modulator incorporated within a monolithic integrated chip to phase shift the received signal. The QPSK modulator can employ positive-intrinsic-negative (PIN) diodes as switches to form a switch based delay line quadra-phase shift key modulator (PIN switch based delay line QPSK MMIC). The modulator can be utilized to add phase delays to the received signal (e.g., 0, 90 and 180 degrees, and combinations thereof.

In other aspects of the present invention, various phase shift technologies can be employed. For example, transmission and/or reflective based approaches, including binary, reflective, hybrid reflective and switching techniques can be employed. In addition, diagnostics components can be employed in connection with the PIN switch based delay line QPSK MMIC in order to verify chip integrity and facilitate diagnosis and trouble shooting chips. Furthermore, methods are provided that employ PIN switch based delay line QPSK MMIC to modulate signals, including signals associated with auto-tracking systems.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an exemplary modulation system, in accordance with an aspect of the present invention.

FIG. 2 illustrates an exemplary signal phase-shifting system that facilitates antenna auto-tracking, in accordance with an aspect of the present invention.

FIG. 3 illustrates an exemplary binary phase shifting component, in accordance with an aspect of the present invention.

FIG. 4 illustrates an exemplary reflective phase shifting component, in accordance with an aspect of the present invention.

FIG. 5 illustrates an exemplary hybrid reflective phase shifting component, in accordance with an aspect of the present invention.

FIG. 6 illustrates an exemplary switched filter component, in accordance with an aspect of the present invention.

FIG. 7 illustrates an exemplary receiving system employing a QPSK MMIC, in accordance with an aspect of the present invention.

FIG. 8 illustrates an exemplary transmitting system employing a QPSK MMIC, in accordance with an aspect of the present invention.

FIG. 9 illustrates an exemplary signal processing method employing monolithic chip technology with shift key modulation, in accordance with an aspect of the present invention.

FIG. 10 illustrates an exemplary method that facilitates antenna auto-tracking, in accordance with an aspect of the present invention.

FIG. 11 illustrates an exemplary microprocessor-based system that can be employed in accordance with an aspect of the present invention.

### DETAILED DESCRIPTION OF INVENTION

The present invention provides systems and methods for low loss monolithic extremely high frequency quadra-phase shift key (QPSK) modulators. Microwave monolithic integrated circuit (MMIC) technology is utilized, wherein positive-intrinsic-negative (PIN) diodes are fabricated within the MMIC and configured to create switch based delay line modulation. The systems and methods can be employed in connection with antenna signal auto tracking, and provide for reduced phase shifting assembly size, cost and complexity, consistent fabrication, and improved performance.

As used in this application, the terms “component” and “system” are intended to refer to a signal processing/communications related entity, either hardware, a combination of hardware and software, software, or software in execution. For example, a component and system can be, but are not limited to being, an integrated circuit integral to a signal processor, a signal processor, an interconnection, a client/host, modulator, a thread of execution, a program, and/or a computer. By way of illustration, both the signal-processing algorithm running on a signal processing chip and the signal-processing chip can be a component. Additionally, one or more components may reside within a process and/or thread of execution and a component may be localized on one computer and/or distributed between two or more computers.

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

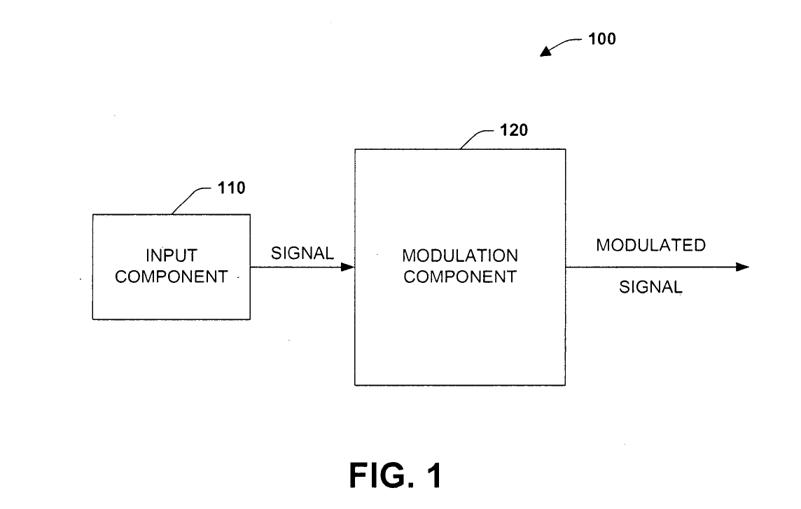

FIG. 1 illustrates a system 100 that modulates a received signal, in accordance with an aspect of the present invention. The system 100 comprises an input component 110 that receives the signal and conveys the signal to a modulation component 120 where the signal can be suitably processed. The input component 110 and the modulation component 120 can be coupled via various transmission technologies such as electrical, electromagnetic (e.g., wireless) and optical, for example. In addition, optional components (not shown) such as amplifiers and filters, for example, can be employed in connection with (e.g., between) the input component 110 and the modulation component 120 to provide for signal conditioning and/or other processing.

The input component 110 can be transceiver, wherein it receives signals from devices that transmits information, or data, such as an antenna, a satellite, a cell phone, and a radio, for example, and then transmits the information to the modulation component 120. In addition, the input component 110 can be coupled to a microprocessor-based component (e.g., computer and signal processor (e.g., DSP)) in order to facilitate conveyance of raw or processed information from the microprocessor-based component to the modulation component 120.

The modulation component 120 can be employed as a phase shift key modulator (e.g., a quadra-phase shift key, or QPSK) to modulate the signal via phase shifting. As known, phase shift key modulation provides for angular modulation via varying the phase of the carrier relative to a reference. In one aspect of the present invention, a binary phase shifter with a two-path phase shifting section can be employed. The two paths can be PIN switched delay lines, wherein one path can be a reference path for the signal and the other path can be the delay path that delays the signal. In general, the delay path is constructed to be longer than the reference path by an equivalent electrical length that corresponds to a desired phase shift (e.g., 90 and 180 degrees). The two-path phase shifting section can provide for two-phase states. It can be appreciated that coupling phase shifting sections can provide for additional phase states. For example, coupling two two-phase shifting sections provides for four phase states (e.g., for QPSK modulation), coupling three two-phase shifting sections provides for eight phase states, and coupling n two-phase shifting sections provides for 2ⁿ phase states.

In another aspect of the present invention, a reflective phase shifter can be employed. Reflective types typically comprise one or more phase shifting sections (e.g., in series), wherein a respective section can include a hybrid coupler and PIN diode switches. Phase delays are introduced by changing the termination impedance state via the switches. Similar to the binary phase shifter described above, phase shifting sections can be coupled to provide for m states, including four phase states to construct a QPSK modulator.

In yet another aspect of the present invention, a hybrid reflective shifter, comprising both the delay line section and the reflective section described supra, can be employed. In combination, the delay line section and the reflective section can provide various phase states, including four phase states for QPSK modulation. In still another aspect of the present invention, a switched filter section can be tuned for a particular phase shift over various frequencies. The switched filter typically comprises phase shift networks (e.g., parallel), wherein respective networks provide for two phase states, and coupling networks can provide for additional phase states, for example, coupling two networks can provide for four phase states that can be employed to achieve QPSK modulation.

It is noted that various modulation techniques (e.g., analog and/or digital) can be utilized in accordance with an aspect of the present invention. For example, analog modulation such as amplitude modulation (AM) and/or frequency modulation (FM) can be employed within and/or in connection with the system 100. Digital modulation such as amplitude shift keying (ASK), frequency shift keying (FSK), phase shift keying (PSK) modulation (as noted above), and/or Quadrature Amplitude Modulation (QAM) (e.g., a data transfer optimization) techniques can be employed within and/or in connection with the system 100.

The modulation component 120 can include positive-intrinsic-negative (PIN) diodes, as briefly noted supra, as switches to form a switch based (e.g., delay line) shift key modulator (e.g., QPSK). PIN diodes can be employed to switch the transmission line such that the signal (e.g., RF) can be routed through various lengths of transmission line. It is to be appreciated that respective transmission line lengths can introduce time delays. For example, delays in multiples of 90 and 180 degrees of phase rotation, to generate 0 degrees, 90 degrees, 180 degrees and 270 degrees phase shifts.

As known, PIN diodes are semiconductors, with a neutrally doped intrinsic region between p-doped and n-doped semiconductor regions, that can behave like variable resistors at RF and microwave frequencies. The associated resistance values can be determined by the forward biased DC current. Typically, Silicon (Si) or Gallium Arsenide (GaAs), having high resistivity and long lifetime, is employed to construct PIN diodes, wherein a P-region is diffused into a first side of the material and an N-region is diffused into a second side of the material such that the I-region, or intrinsic Si or GaAs region isolates the P- and N- regions.

The modulation component 120, including the PIN diodes, can be formed employing a monolithic technique such as a microwave monolithic integrated circuit (MMIC) technology. Monolithic approaches provide for single substrate circuitry that typically is more reliable and reproducible than conventional circuits constructed from a plurality of components that are coupled via wire wrap, ball bonds, solder joints, surface mount, and the like. In addition, constructing PIN diode phase shifters within an MMIC provides for phase shifters that can be consistently fabricated for extremely high frequency (e.g., 30-300 GHz) operation. Furthermore, utilizing MMICs can reduce footprint and assembly cost, and increase performance via mitigating parasitic reactance.

It is to be appreciated that the system 100 can be employed in connection with auto-tracking systems. For example, the system 100 can facilitate antenna (e.g., satellite, aircraft and spacecraft) auto-tracking via providing quadra-phase shift key (QPSK) modulation of an associated signal. Conventional approaches employ QSPK; however, current industry standard employs ferrite based phase shifters, which can be temperature and frequency sensitive, wherein tight thermal control, complex drive electronics, and calibration routines are employed. In addition, the physical size and complexity of the phase shifters, and associated drive electronics and thermal controls can make these assemblies costly. The present invention employs MMICs with PIN diode switched based delay line QPSK modulator, which can reduce assembly size, cost and complexity associated with ferrite phase shifters, and increase performance. In addition, and as noted above, employing MMICs can provide for more reliable and reproducible circuitry that can be consistently fabricated.

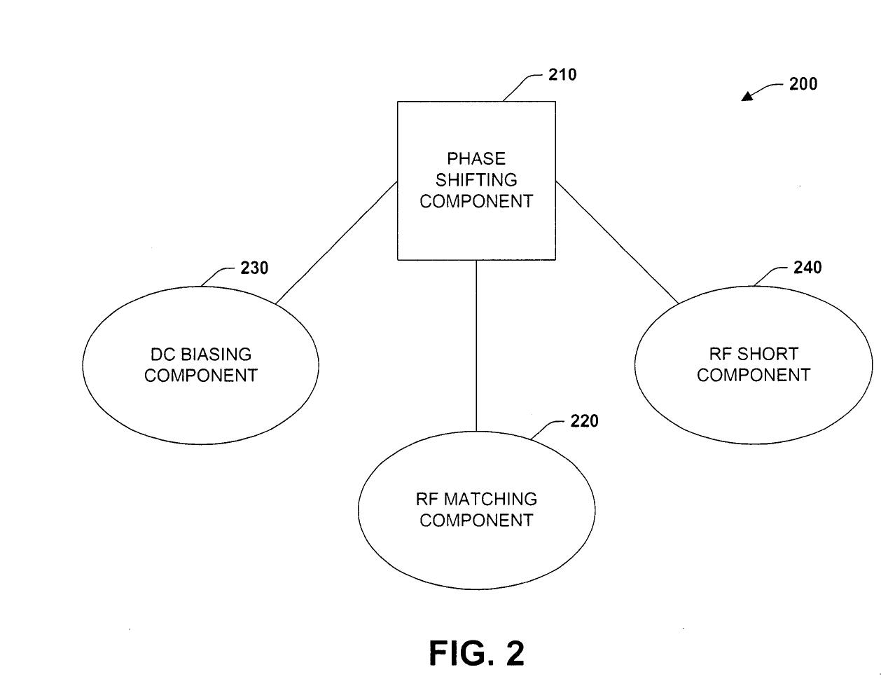

FIG. 2 illustrates a system 200 that can facilitate auto-tracking systems, in accordance with an aspect of the present invention. The system 200 includes phase shifting component 210, frequency matching component 220, DC bias component 230 and frequency shorting component 240.

The phase shifting component 210 can be employed as a quadra-phase shift key (QPSK) modulator MMIC, as describe above (e.g., the modulating component 120). As noted previously, the QPSK modulator can utilize PIN diodes as switches based for switched delay line QPSK modulation. Employing MMIC technology can provide for more compact and less expensive circuits, and/or mitigate parasitic reactance inherent in hybrid integrated circuits, which can degrade integrated circuit performance in the microwave and millimeter-wave spectrum. Examples of systems that can exploit the advantages of MMICs include receivers and transmitters (e.g., antennas, such as phased-array), where MMICs provide for reduced package size, uniform circuit performance, reduced interconnect costs and improved performance at high frequencies.

Phase shifting techniques can include reflective and/or transmission phase shifters that can be employed to impart a repeatable and controllable change of phase to a received signal without substantially affecting signal amplitude. For example, when employed with phased-array antennas, phase shifters can be utilized to control beam shape and direction.

Transmission phase shifter approaches switch the signal between a short and a long length of transmission line to develop a phase associated with a transmission line propagation constant that is based on the differential transmission line length. Transmission-type phase shifters typically are two-terminal devices that change the phase of the input signal as it passes through the circuit. Examples of transmission-type phase shifters include: hybrid coupled, loaded line, and switched line.

Reflective phase shifters change the reactance of a transmission line, which changes the propagation constant along the line. Reflection-type phase shifters typically are one-terminal devices that rely on the reflection of the signal from a termination (e.g., short, open, or other impedance) that has a reflection coefficient with a magnitude of about one. Hybrid phase shifters employ transmission and reflection-type phase shifters in connection.

The phase shifters employed in the present invention typically are constructed with PIN diodes; however, Metal-Semiconductor-Field-Effect-Transistors (MESFETs), and/or varactor diodes can be utilized in accordance with aspects of the present invention. As noted above, PIN diodes can be employed as switches to vary the signal through different transmission line lengths to introduce time delays. PIN diodes can be formed from Si, GaAs and/or variants thereof via applying P-type doping to end and N-type doping on another end to form an I-region between P- and N- regions.

When the PIN diode is forward biased, holes and electrons are injected from the P and N regions into the I-region. These charges do not recombine immediately. Instead, a finite quantity of charge remains stored and results in lowering the resistivity of the I-region. The quantity of stored charge, Q, depends on the recombination time r(the carrier lifetime) and the forward bias current I_{F} and can be defined as: Q=I_{F}τ, in units of Coulombs. The resistance of the I-region under forward bias R_{S} is inversely proportional to Q, and can be defined as:

$${R}_{S} = \frac{{W}^{2}}{( {μ}_{N} + {μ}_{p} ) Q} ,$$

in units of Ohms, where W=I-region width; μ_{N}=electron mobility; and μ_{P}=hole mobility.

Combining the foregoing charge and resistance equations renders R_{S} in terms of current, or as:

$${R}_{S} = \frac{{W}^{2}}{( {μ}_{N} + {μ}_{p} ) τ {I}_{F}} ,$$

in units of Ohms. The maximum forward resistance R_{S}(max) of the PIN diode generally is indicated at about 100 mA forward bias current and the minimum forward resistance R_{S}(min) generally is indicated at about 10 μA forward bias current. Low resistance limitations result from package parasitic inductances and junction contact resistances, whereas the high resistance range typically is limited by the effect of the diode capacitance C. The PIN diode reactance can be “tuned out” in order to configure the diode for maximum dynamic range.

At DC and very low frequencies, the PIN diode can be substantially similar to a PN diode, wherein the diode resistance can be described via the dynamic resistance of the I-V characteristics at any quiescent bias point. However, the DC dynamic resistance point is not valid in PIN diodes at frequencies when the period is shorter than the transit time of the I-region. The frequency at which this occurs, f_{τ}, can be referred to as the transit time frequency and can be considered the lower frequency limit. The lower frequency limit is primarily a function of W, the I-region thickness in microns, and can be expressed as:

$${f}_{τ} = \frac{1300}{{W}^{2}} ,$$

in units of MHz.

At high RF frequencies, when the PIN diode is at about zero or reverse bias, the PIN diode can appear as a parallel plate capacitor. As such, the PIN diode can be independent of the reverse voltage, for example as expressed in:

$$C = \frac{ɛ A}{W} ,$$

where: ε is the silicon dielectric constant; A is the junction area; and W is the I-region thickness. The lowest frequencies at which this effect manifests typically is related to the dielectric relaxation frequency of the I-region, f_{τ}, which can be computed as:

$${f}_{τ} = \frac{I}{2 πρɛ} ,$$

where: ρ is the I-region resistivity. At frequencies much lower than f_{τ}, the capacitance characteristic of the PIN diode can resemble a varactor diode.

Associated with the diode capacitance is a parallel resistance, Rp, which represents the net dissipative resistance in the reverse biased diode. At low reverse voltages, the finite resistivity of the I-region can result in a lossy I-region capacitance. As the reverse voltage is increased, carriers are depleted from the I-region resulting in a lossless capacitor. The reverse parallel resistance of the PIN diode, Rp, can additionally be affected by a series resistance in the semiconductor or diode contacts.

Similar to PIN diodes, MESFETs phase shifters can be formed from Si or GaAs. Such phase shifters typically comprise a conducting channel positioned between a source and drain contact region. The carrier flow from source to drain can be controlled, for example, by a Schottky metal gate. Control of the channel can be obtained via varying the depletion layer width underneath the metal contact, which modulates the thickness of the conducting channel and thereby the current.

In contrast to Metal Silicon Oxide Field Effect Transistors (MOSFETs), MESFETs can achieve higher mobility of the carriers in the channel. Since the carrier located in the inversion layer of a MOSFET typically have a wave-function, which extends into the oxide, their mobility (e.g., surface mobility) typically is less than half of the mobility of bulk material. As the depletion region separates the carriers from the surface their mobility is close to that of bulk material. The higher mobility leads to a higher current, transconductance and transit frequency of the device.

The RF matching component 220 can be employed to pass signals within a desired frequency band, maximize power transfer and/or block frequencies, the DC bias component 230 can be employed to vary the DC level affect the impedance state, and the high Q RF short component 240 can be employed to provide an RF short for the DC lines.

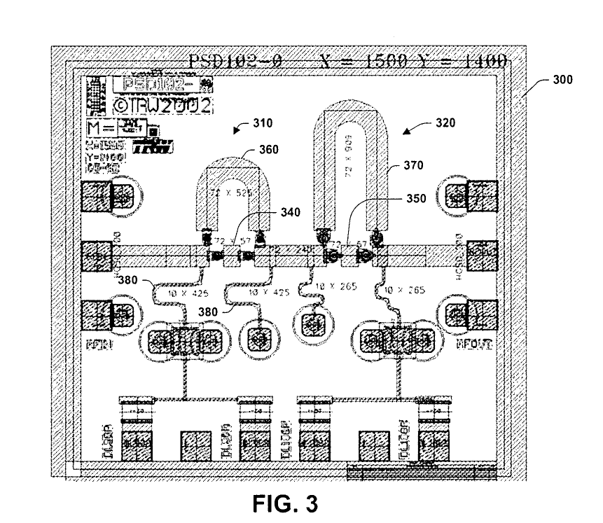

FIG. 3 illustrates an exemplary binary phase shifting component 300, in accordance with an aspect of the present invention. The binary phase shifting component 300 comprises a first phase shifting region 310 coupled with a second phase shifting region 320, wherein the phase shifting regions can be employed in connection to generate a four phase states for QPSK modulation. It is to be appreciated that monolithic integrated chip technology can be employed in connection with constructing the component 300.

Respective regions 310, 320 of the binary phase shifting component 300 can include two-path PIN diode switched delay lines. The primary paths 340, 350 of the regions can be employed as reference paths that provide a pass through channel for the signal without adding a delay. The secondary path 360 (e.g., delay path) associated with the first region 310 can be utilized to introduce a first delay, and the secondary path 370 associated with the second region 320 can be utilized to introduce a second delay. Generally, introduced delays correlate to delay path length, or electrical length, wherein a longer path is associated with a greater phase rotation. It is noted that delay path coupling (not shown) can be employed to mitigate dispersion effects.

As depicted, the delay paths are longer than the reference paths (e.g., by an electrical length at a frequency of operation), and therefore, a delay, or phase rotation is introduced into the delay paths, relative the reference paths. In addition, the secondary path 370 is longer than the secondary path 360 such that the phase rotation for the secondary path 370 is greater than that of the secondary path 360. As an example, the primary paths 340, 350 and the secondary paths 360, 370 can be constructed such that the primary paths 340, 350 can be associated with 0 degrees of phase rotation, the secondary paths 360 can be associated with 90 degrees of phase rotation, and the secondary path 370 can be associated with 180 degrees of rotation.

The binary phase shifting component 300 optionally can comprise a tuning region 380. The tuning region 380 can include DC bias and/or RF matching circuitry. The DC bias circuitry can be employed to vary the level of DC bias applied to the PIN diode to affect the impedance state. When the DC bias changes the impedance from a lower value to a higher value, the PIN diode behaves as a switch, wherein the switch is in the “on” state when forward biased (e.g., low impedance) and in the “off” state when about zero or reverse biased (e.g., high impedance). The RF matching circuitry can be employed to pass signals within a desired frequency band and maximize power transfer of such signals, and/or block frequencies outside of the desired frequency band.

It is to be appreciated that the first region 310 can provide 1-bit, or two states of phase information and the second region 320 can provide 1-bit, or two states of phase information. For example, when encoding for 90 degrees of phase shift, the 0 degree phase shift can be encoded as “0” and the 90 degree phase shift can be encoded as “1,” or the −45 degree phase shift can be encoded as “0” and the 45 degree phase shift can be encoded as “1.” In another example, when encoding for 180 degrees of phase shift, “0” can indicate a phase shift of 0 degrees and “1” can indicate a phase shift of 180 degrees, or “0” can indicate a phase shift of −90 degrees and “1” can indicate a phase shift of 90 degrees. Employing the first and second regions in combination can render a 2-bit, or a 4 phase-state system. For example, the state “00” can represent 0 degrees of phase shift, “01” can represent 90 degrees of phase shift, “11” can represent 180 degrees of phase shift and “10” can represent 270 degrees of phase shift.

It is noted that the foregoing is not limitative. For example, the bit can represent different phase shifts, including phases more, less or between 90 and 180 degrees. In addition, more than one bit can be employed in order to encode additional phase angles. For example, employing two bits can provide for four phase angles (quadra-phase, as depicted above). In other aspects of the present invention, three bits can be employed to provide for eight phase angles and n bits can provide for 2ⁿ phase angles.

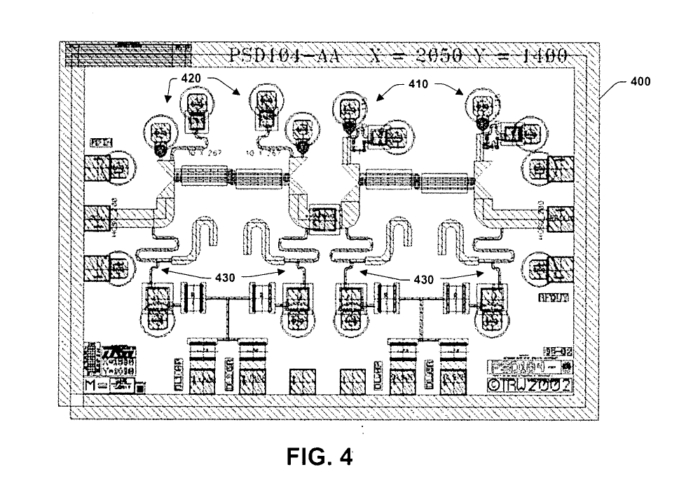

FIG. 4 illustrates an exemplary reflective phase shifting component 400, in accordance with an aspect of the present invention. The reflective phase shifting component 400 comprises a first region 410 and a second region 420 that can be employed in series with various other components to construct a four phase QPSK modulator (e.g., via monolithic integrated chip technology).

As noted supra, reflective phase shifters affect the reactance of a transmission line in order to introduce a delay. Respective regions 410, 420 can include a 90-degree hybrid and two PIN diode switches. The PIN diode in region 410 can be variously terminated (e.g., high and low) to switch from a high impedance state to a low impedance state, in order to establish a 180 degrees phase change. In addition, an additional phase shift segment can be employed with region 420 to generate a 90-degree differential.

The reflective phase shifting component 400 optionally includes a tuning region 430 for setting the high Q RF short and DC bias. As noted above, DC bias circuitry can be employed to vary the level of DC bias applied to the PIN diode to affect the impedance state (e.g., low impedance and high impedance). The high Q RF short circuitry can be employed to provide an RF short for the DC lines.

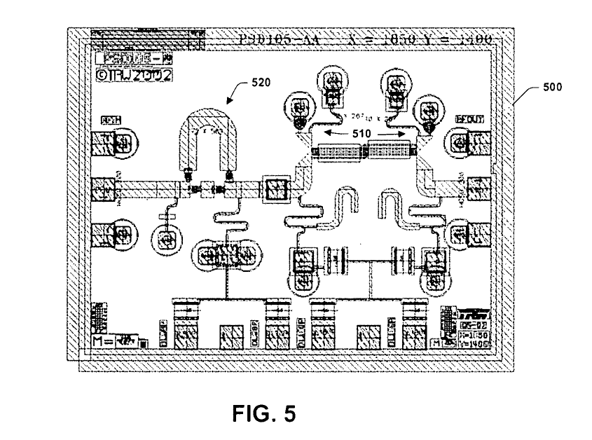

FIG. 5 illustrates a hybrid reflective phase shifting component 500, in accordance with an aspect of the present invention. The hybrid reflective phase shifting component 500 comprises a reflective phase shifting section 510 (e.g., as described above (e.g., in connection with component 400)) and a delay line section 520 (e.g., as described above (e.g., in connection with component 300)).

The 180 degree phase shift can be achieved by employing the reflective phase shifting section 510. Power can be applied to the PIN diodes within the section 510 to variously terminate the hybrid couplers and switch states from high impedance to low impedance, as described previously. Changing the state of the PIN diodes can provide for the 180-degree phase shift. Resonators can be employed to increase the off state impedance and provide bias to the PIN diodes.

The 90 degree phase shift can be achieved by employing a two-path switched delay line within section 520. As noted above, the primary path of the region can be employed as reference paths and the secondary path can be utilized as a delay path, wherein the delay is associated with the delay path length, or electrical length at the operation frequency. Basically, the greater the difference in the length of the path, the greater the phase rotation. In addition, section 510 can be associated with a tuning region for DC bias and/or RF matching circuitry, as described in detail above.

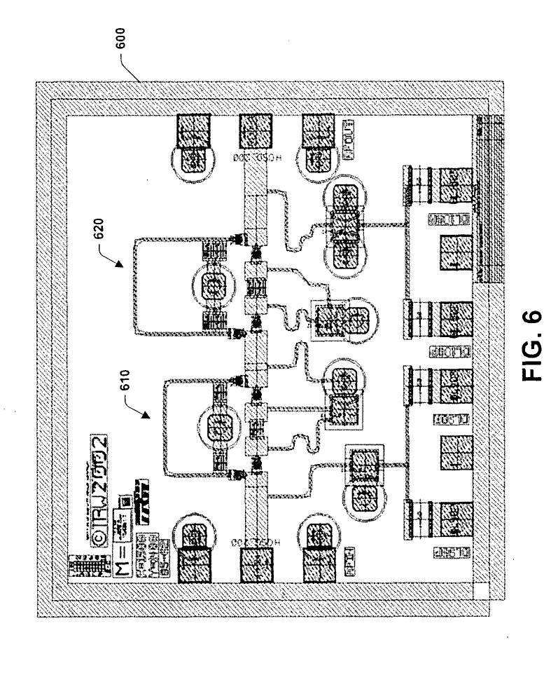

FIG. 6 illustrates a switched filter component 600, in accordance with as aspect of the present invention. The switched filter component 600 can be employed to achieve a particular phase shift over a broad frequency. The switched filter component 600 (e.g., an MMIC, as described herein) comprises two-phase shifting sections 610, 620. The first section 610 includes two parallel phase shift networks that create a wide band +45 degree or −45 degree phase shift, or 90 degrees of phase shift. The second section similarly includes two parallel phase shift networks, however, the networks of second section 620 can be utilized to create a wide band +90 degree or −90 degree phase shift, or 180 degrees of phase shift.

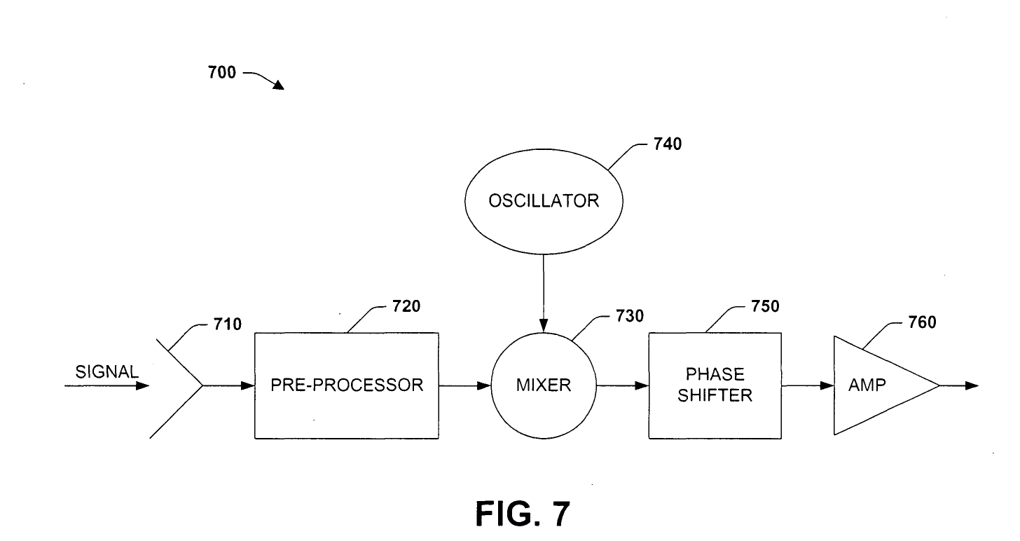

FIG. 7 illustrates an exemplary receiving system 700, in accordance with as aspect of the present invention. The receiving system 700 comprises a plurality of stages including pre-processing, mixing, phase shifting, and amplifying. It is to be appreciated that the stages and associated components depicted in the systems 700 provide for one example. However, various other system configurations including additional and/or different stages and components can be employed in accordance with as aspect of the present invention. For example, the phase shifting stage can occur prior to the mixing stage.

The receiving component 710 can be employed to receive signals such as RF signals (e.g., extremely high frequency signals) and/or signals outside the RF band. The receiving component 710 can be, for example, an antenna associated with a spacecraft, a satellite, an aircraft, an automobile, a mobile device, or an amphibious vehicle. After receiving the signal, the receiving component can convey the signal to the preprocessing component 720.

The pre-processing component 720 can filter the noise in the signal. For example, RF signals typically are associated with low power levels (e.g., near the noise floor), and can be processed with a low-noise amplifier (LNA). When the gain of the LNA is sufficiently large, the noise contribution from the remaining stages of the system 700 can be relatively small since the noise added via the other stages is divided by the gain of the LNA and the LNA gain and noise figure (the measure of noise added by the LNA) determine the receiver noise characteristics. The preprocessing component 720 can additionally be employed to band pass filter the signal.

After pre-processing, the signal can be conveyed to the mixer 730. In general, mixers convert an input at one frequency to an output at another frequency (e.g., an intermediate frequency (IF)) to permit filtering, phase shifting, and/or other data processing operation at a frequency more easily implemented by the circuits. The oscillator 740 can generate a local oscillator (LO) signal that can be fed into the mixer, wherein the mixer 730 can generate the output signal via combining the signal from the pre-processor 720 with the LO signal from the oscillator 740 to generate a signal at the intermediate frequency (IF) (e.g., fRF-fLO or fLO-fRF) and harmonics of the IF, RF, and LO frequencies.

For example, the system 700 can be employed to acquire data within a band from 75 to 110 GHz. Filters associated with this band can have low Q or high loss, which degrades the receiver noise characteristics. Therefore, it can be advantageous to shift the received signal's frequency to a lower value where low-loss filters can be utilized. Typically, this is achieved without degrading the input signal's amplitude or introducing additional noise. The conversion efficiency of the mixer usually depends on the LO drive power.

The mixed signal can be conveyed to the phase shifter 750 for signal modulation. The phase shifter 750 can be a PIN diode switch based delay line QPSK modulator MMIC, as described herein. For example, and as described supra, the phase shifter can be a binary phase shifter, a reflective phase shifter, a hybrid reflective phase shifter, or a switched phase filter.

The binary phase shifter can include two-path PIN diode switched delay lines, wherein a first path can be a reference paths and a second path can be a delay path, wherein the length associated with the second path is based on an electrical length that corresponding to a phase rotation. Employing two such phase shifters in series can provide for binary (four bit) quadra-phase shift key modulation.

The reflective phase shifter can include two regions of circuitry, where respective regions can include a 90-degree hybrid and two PIN diode switches. Reflective phase shifters provide delay via changing the reactance of a transmission line. For example, PIN diodes can be terminated high or low to switch from a high impedance state to a low impedance state, in order to establish a 180 degrees phase change. In addition, an additional phase shift segment can be employed to generate a 90-degree differential.

The hybrid reflective phase shifter typically includes a reflective phase shifter and a delay line phase shifter. In general, 90 degree phase shifts can be provided via the two-path switched delay line and 180 degree phase shifts the reflective phase shifter.

The switched filter can be employed to achieve a particular phase shift over a broad frequency via phase shift networks (e.g., two parallel) that create +45 degree or −45 degree phase shift (90 degree shifts), or +90 degree or −90 degree phase shift (180 degree shift).

In addition, the phase shifter 750 can include DC bias, RF matching and/or high Q RF short circuitry. As described previously, the DC bias circuitry can be employed to vary the level of DC bias applied to the PIN diode to affect the impedance state, the RF matching circuitry can be employed to pass signals within a desired frequency band, maximize power and/or block frequencies, and the high Q RF short circuitry can be employed to provide an RF short for the DC lines.

After phase shifting, the amplifier 760 can be utilized to increase the power, or gain of the signal (e.g., via transconductance or current). The number of stages in the amplifier typically is dependent on the desired gain and frequency, since transistor output power decreases with increasing frequency. The amplified signal can then be further processed and/or utilized.

It is to be appreciated that the foregoing can be employed in connection with antenna auto-tracking. For example, the system 700 can be associated with a phased-array antenna, wherein the direction and shape of the main beam radiated or received by the antenna depends on the relative phase (e.g., set by the phase shifter) shift and power level of the receiver.

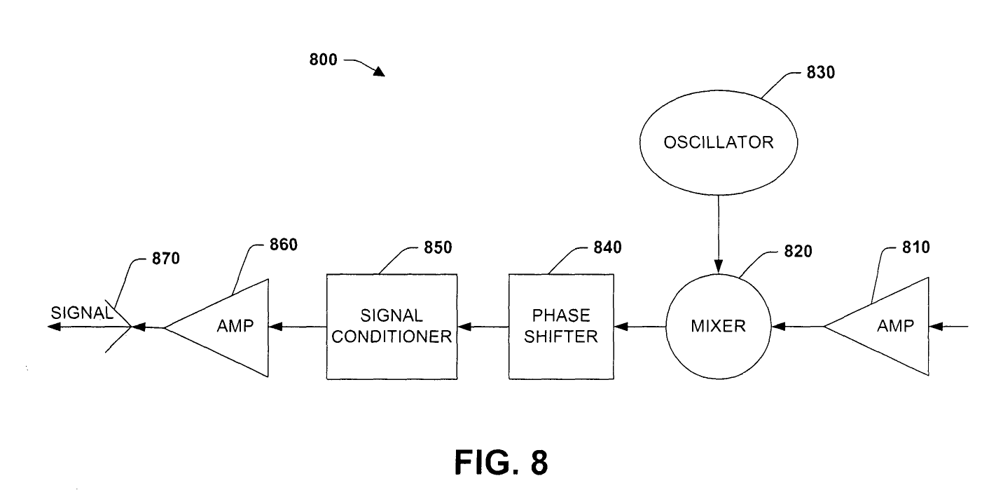

FIG. 8 illustrates an exemplary transmitting system 800, in accordance with as aspect of the present invention. A signal to be transmitted can be provided to the amplifier 810, wherein the signal power can be suitably amplified. The amplified signal can be conveyed to the mixer 820, where the mixer 820 can generate a signal at an intermediate frequency from the amplified signal and a signal from the local oscillator 830, as described above.

After generating the intermediate frequency signal, the phase shifter 840 can be employed to phase shift the signal. In one aspect of the present invention, the phase shifter can be PIN diode switch based delay line PSK modulator within an MMIC, configured for QPSK. Various phase shifting techniques can be employed with such an MMIC. As described previously, suitable phase shifting techniques comprise transmission line and reflective types, including binary, reflective, hybrid reflective and switched phase filters.

The phase shifted signal can be conditioned prior to being transmitted via the signal conditioner 850. For example, the signal can be encrypted, encoded, and/or encapsulated within an envelope. In another example, the signal can be filtered. The power amplifier 860 can be employed to increase the gain of the signal. The transmitting component 870, can then transmit the signal.

Similar to the system 700, the foregoing can be employed in connection with antenna auto-tracking. In addition, the stages depicted are provided for explanatory purpose. In other aspects of the invention, the components can be arranged differently. For example, the phase shifting stage can occur before mixing or after signal conditioning. Furthermore, additional and/or different stages and/or components, including less stages and/or components, can be employed in accordance with an aspect of the present invention.

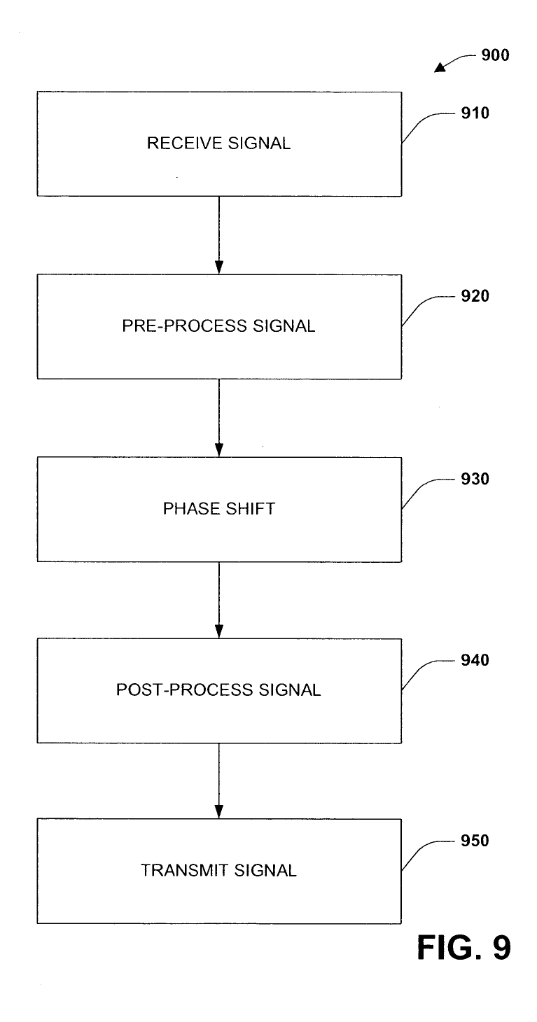

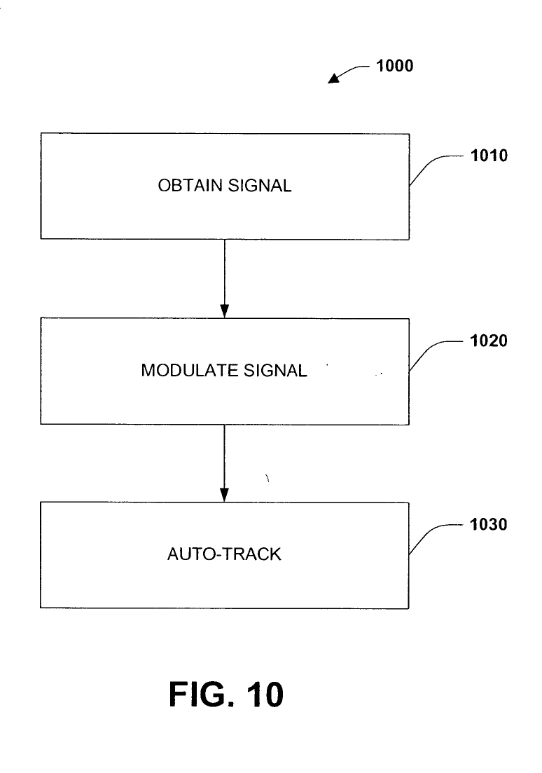

FIGS. 9 and 10 illustrate methodologies 900, in accordance with an aspect of the present invention. While, for purposes of simplicity of explanation, the methodologies may be shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

FIG. 9 illustrates a method 900 in accordance with an aspect of the present invention. Proceeding to reference numeral 910, a signal is received. The received signal can be a signal transmitted via another device or a signal to be transmitted to another device. For example, in one aspect of the present invention, the signal can be accepted by a receiving component, as described above. In another aspect of the present invention, the signal can be provided by a computer or other micro-processor based component. It is to be appreciated that a transceiver can be employed, wherein signals remotely manifested and/or locally obtained through hardware and/or software can be received. In yet another example, the signal can be a reflected signal that was previously transmitted.

At 920, the received signal can be pre-processed. For example, the signal can be filtered for noise. In another example, the signal can be amplified (e.g., for a particular dynamic range). In yet another example, a low, high, and/or band pass filter can be applied to enhance desired frequencies and/or suppress undesired frequencies. In still another example, the signal can be decrypted and/or decoded.

The pre-processed signal can be phase shifted at 930. For example, quadra-phase shift key modulation can be employed to generate four phase states for the signal (e.g., 0, 90, 180 and 270 degrees). Various phase shifting techniques can be employed, including binary, reflective, hybrid reflective, and switched phase shifting. As described in detail above, a PIN diode switch based delay line QPSK modulator MMIC can be utilized in accordance with an aspect of the present invention.

At reference numeral 940, the signal can be post-processed. Similar to pre-processing, the signal can be amplified (e.g., via a power amplifier). In addition, the signal can be encrypted, encoded and/or embedded within an envelope. At 950, the processed signal can be transmitted. For example, wherein the signal is received from a remote device, the signal can be transmitted and utilized by a system (e.g., computer based) associated with the receiver. Where the system is processing the signal for utilization by another device, the signal can be transmitted via a suitable transmission medium such as electromagnetic radiation (e.g., via an antenna), optical coupling, and/or an electrical channel (e.g., Ethernet).

FIG. 10 illustrates a method 1000 to facilitate antenna auto-tracking in accordance with an aspect of the present invention. At 1010, a signal associated with antenna positioning is received. The signal can be indicative of antenna positioning (e.g., azimuth, elevation, and skew), signal strength, and shape. Next at reference numeral 1020, the signal can be quadra-phase shift key modulated (e.g., binary, reflective, hybrid reflective, and switched) via a PIN diode switch based delay line QPSK modulator MMIC, as described herein. At 1030, the modulated signal can be employed in connection with an auto-tracking system to facilitate antenna auto-tracking.

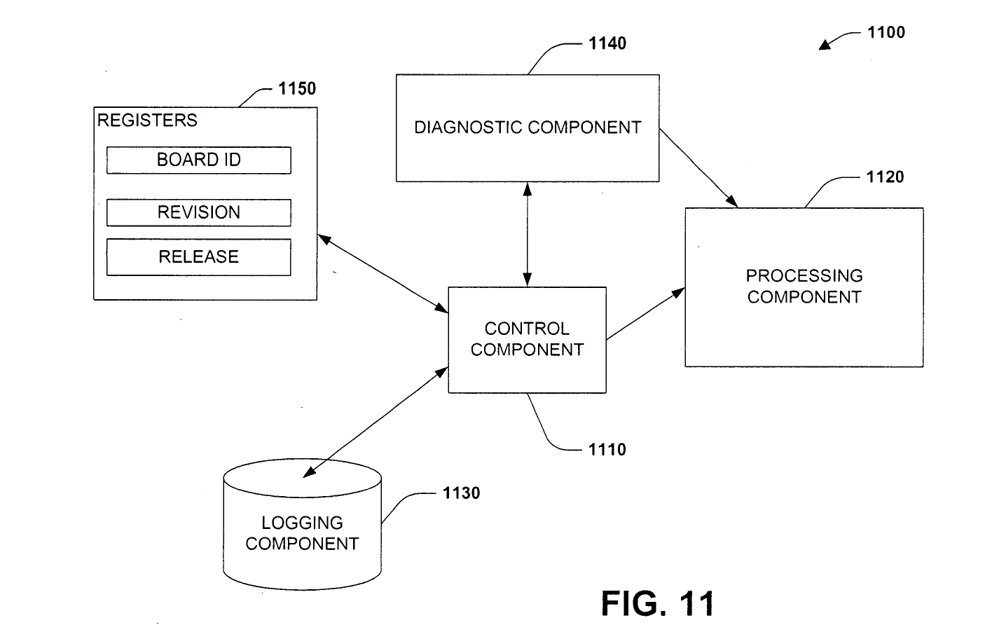

FIG. 11 illustrates a system 1100 with board level diagnostics in accordance with an aspect of the present invention. The system 1100 includes at least one control component 1110, a diagnostics component 1120, a logging component 1130, a plurality of registers 1140, and a processing component 1150.

Upon applying power to the system 1100, the control component 1110 can transmit a reset signal that can elicit a boot of the processing component 1120 and various other components (not shown). The logging component 1130 can be activated to store system activities, including initialization and diagnostics performed during booting. The stored information can be utilized to maintain permanent records and/or generate reports. In addition, the log can be utilized to trouble shoot the system and/or module errors.

The processing component 1120 can include a PIN diode switch based delay line QPSK modulator MMIC, as described herein, to modulate signals, for example, signals associated with antenna auto-tracking. Conventionally, modulation of such signals is achieved via pseudo-monopulse systems employing a QPSK modulator at the antenna receive frequency. Such conventional systems typically employ ferrite based phase shifters, which can be temperature and frequency sensitive, include tight thermal control and complex drive electronics, and can be expensive. Employing a PIN diode switch based delay line QPSK modulator MMIC can reduce assembly size, cost and complexity associated with ferrite phase shifters, and improve performance. In addition, such MMICs provide for consistently fabricated phase shifters for extremely high frequency (EHF) operation.

During booting, the diagnostic component 1140 can verify the integrity of the processing component 1120. If no errors are diagnosed, then the diagnostic component 1140 can return a message to the control component 1110 indicating that the processing component 1120 initialized without errors. If errors are discovered, then the control component 1110 can dump the contents of the registers component 1150 and the results of the diagnostic testing to the logging component 1130. The content of the registers component 1150 can provide the processing component 1110 board-level information such as board id, hardware revision, firmware revision, and software release.

It can be appreciated that the diagnostics functionality can extend beyond boot diagnostics. For example, diagnostics can be utilized to upload new, specific or beta software and firmware, and patches. The control component 1110 can additionally facilitate the loading and testing of the software

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim

1. A signal processing system, comprising:
a component that receives an antenna pointing signal; and
a monolithic shift key (SK) modulation component, incorporating PIN diodes, that phase shift the signal, wherein the phase shifted signal is subsequently utilized to facilitate auto-tracking of the antenna.

2. The system of claim 1, the SK modulation component employing one or more binary phase shifters.

3. The system of claim 2, the respective binary phase shifters comprising multiple phase shifting paths in series to introduce a plurality of phase shifts based on the number of paths.

4. The system of claim 2, the binary phase shifters employed as a quadra-phase (QPSK) modulator to generate four phase shifts for the signal.

5. The system of claim 2, respective binary shifters comprising paths constructed in accordance with an equivalent electrical length that corresponds to a desired phase shift.

6. The system of claim 1, the SK modulation component employing one or more reflective phase shifters.

7. The system of claim 6, respective reflective phase shifters comprising two phase shifting sections, wherein respective phase shifting sections comprise a hybrid coupler and two PIN diode switches.

8. The system of claim 6, respective reflective phase shifters configured to generate at least a 90-degree phase shift and a 180-degrees phase shift via changing termination impedance state via the PIN diodes, wherein the 90 and 180 degree phase shifts are employed in connection to modulate the signal through four phase states.

9. The system of claim 1, the SK modulation component employing a hybrid reflective phase shifter comprising a binary phase shifter and a reflective phase shifter.

10. The system of claim 1, the SK modulation component employing a switched filter phase shifter that can be tuned for a particular phase shift over a plurality of frequencies.

11. The system of claim 10, the switched filter phase shifter comprising two parallel phase shifting networks in series, wherein respective networks provide two phase states, and coupling the networks provides for four phase states.

12. The system of claim 1, the SK modulation component configured as one of an amplitude shift key (ASK), a frequency shift key (FSK), a phase shift key (PSK), and a quadra-phase shift key (QPSK) modulator.

13. The system of claim 1, the monolithic SK modulation component constructed from microwave monolithic integrated circuit (MMIC) technology.

14. The system of claim 1, employed in connection with a satellite, aircraft or spacecraft.

15. The system of claim 1, further comprising a DC bias component employed to affect the impedance state of the PIN diode.

16. The system of claim 1, further comprising a RF matching component employed to pass signals within a desired frequency band, maximize power transfer and filter signals associated with undesired frequencies.

17. The system of claim 1, further comprising a high Q RF short component employed to provide an RF short for DC lines.

18. A transceiver, comprising:
a transceiving component that obtains and conveys signals associated with antenna auto-tracking; and
a phase shifting component that phase shifts the signals via a low loss monolithic quadra-phase shift key (QPSK) modulator.

19. The system of claim 18, the phase shifting component employing one of a binary phase shifter, a reflective phase shifter, a hybrid phase shifter and a switched filter phase shifter.

20. The system of claim 18, the phase shifting component comprising PIN diode switches.

21. The system of claim 18, employed in connection with a satellite, aircraft or spacecraft.

22. The system of claim 18, the monolithic QPSK modulator constructed from microwave monolithic integrated circuit (MMIC) technology.

23. The system of claim 18, further comprising a diagnostic component to verify and facilitate trouble shooting the phase shifting component.

24. A method to process signals that facilitate antenna auto-tracking, comprising:
receiving a signal; and
modulating the signal via a positive-intrinsic-negative (PIN) diode quadra-phase shift key (QPSK) integrated circuit (IC).

25. The method of claim 24, the PIN diode QPSK IC fabricated based microwave monolithic integrated circuit (MMIC) technology.

26. The method of claim 24, the PIN diode employed as a switch to switch between reference and delay lines.

27. The method of claim 24, further comprising one or more of filtering signal noise, amplifying the signal, low pass filtering the signal, high pass filtering the signal, band pass filtering the signal, encrypting the signal, decrypting the signal, encoding the signal, and decoding the signal.

28. The method of claim 24, further comprising employing one of binary, reflective, hybrid, and switched filter based phase shifting.

29. A satellite, aircraft or spacecraft employing the method of claim 24.

30. A communications system, comprising:
means for receiving a signal; and
means for quadra-phase shift key modulating the signal, wherein the modulated signal is employed to facilitate antenna auto-tracking.
